(19) United States
(12) Patent Application Publication
(10) Pub. No.: US 2024/0111072 A1
(43) Pub. Date: Apr. 4, 2024

(54) Method and Apparatus for Petrophysical Classification, Characterization, and Uncertainty Estimation

(71) Applicant: BP Corporation North America Inc., Houston, TX (US)

(72) Inventors: Kevin WOLF, Katy, TX (US); Jingfeng ZHANG, Katy, TX (US); Matthew WALKER, Hersham (GB); Pedro PARAMO DE LA BARRERA, London (GB); Reetam BISWAS, Houston, TX (US); Abdulla KERIMOV, Katy, TX (US)

(21) Appl. No.: 18/474,983

(22) Filed: Sep. 26, 2023

Related U.S. Application Data
(60) Provisional application No. 63/377,779, filed on Sep. 30, 2022.

(51) Int. Cl. G01V 99/00; E21B 49/00; G01V 11/00

(52) U.S. Cl. CPC G01V 99/005; E21B 49/001; G01V 11/002; E21B 47/12

(57) ABSTRACT

Techniques and systems to provide increases in accuracy of property determination of a formation. The techniques include receiving initial well log data, generating augmented well log data including the initial well log data and modeled well log data based on the initial well log data, modifying the augmented well log data to generate a training dataset, training a probabilistic classifier utilizing the training dataset, calculating a probability volume for each lithofluid class of a set of predetermined lithofluid classes utilizing the probabilistic classifier, outputting the probability volume for each lithofluid class of the set of predetermined lithofluid classes as a respective probability of an occurrence of a type of lithofluid class in a reservoir, calculating a posterior probability based on the probability volume for a first lithofluid class of the set of predetermined lithofluid classes, and outputting the posterior probability as a probability of a property of the reservoir.

### CROSS-REFERENCE TO RELATED APPLICATIONS

This application claims benefit of U.S. provisional patent application Ser. No. 63/377,779 filed Sep. 30, 2022 and entitled “Method and Apparatus for Petrophysical Classification, Characterization, and Uncertainty Estimation,” which is hereby incorporated herein by reference in its entirety for all purposes.

### STATEMENT REGARDING FEDERALLY SPONSORED RESEARCH OR DEVELOPMENT

Not applicable.

### BACKGROUND

The present disclosure relates generally to improved processes for calculation of petrophysical rock properties for reservoir characterization.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

A seismic survey includes generating an image or map of a subsurface region of the Earth by sending sound energy down into the ground and recording the reflected sound energy that returns from the geological layers within the subsurface region. During a seismic survey, an energy source is placed at various locations on or above the surface region of the Earth, which may include hydrocarbon deposits. Each time the source is activated, the source generates a seismic (e.g., sound wave) signal that travels downward through the Earth, is reflected, and, upon its return, is recorded using one or more receivers disposed on or above the subsurface region of the Earth. The seismic data recorded by the receivers may then be used to create an image or profile of the corresponding subsurface region.

### SUMMARY

An embodiment of a method for petrophysical classification, characterization, and uncertainty estimation comprises receiving initial well log data, generating augmented well log data comprising the initial well log data and modeled well log data based on the initial well log data, modifying the augmented well log data to generate a training dataset, training a probabilistic classifier utilizing the training dataset, calculating a probability volume for each lithofluid class of a set of predetermined lithofluid classes utilizing the probabilistic classifier, outputting the probability volume of each lithofluid class of the set of predetermined lithofluid classes as a respective probability of an occurrence of a type of lithofluid class in a reservoir, calculating a posterior probability based on the probability volume for a first lithofluid class of the set of predetermined lithofluid classes; and outputting the posterior probability as a probability of a property of the reservoir. In some embodiments, generating the augmented well log data comprises fitting at least one attribute of a selected rock physics model to at least a portion of the initial well log data. In some embodiments, the probabilistic classifier is a Bayesian classifier. In some embodiments fitting at least one attribute of the selected rock physics model to at least a portion of the initial well log data comprises generating a minimum value for a model parameter of the selected rock physics model, generating a maximum value for the model parameter of the selected rock physics model, and sampling across the model parameter to generate a search result. In other embodiments, fitting at least one attribute of the selected rock physics model to at least a portion of the initial well log data comprises comparing the search result against at least a portion of the initial well log data to generate a determination of a best fit between the search result and at least a portion of the initial well log data. In still other embodiments, fitting at least one attribute of the selected rock physics model to at least a portion of the initial well log data comprises applying the best fit between the search result and at least a portion of the initial well log data as the augmented well log data. In some embodiments, modifying the augmented well log data comprises expanding more or more of a porosity range, saturations, fluid type, mineralogy, or volume of shale range based upon the augmented well log data to generate the training dataset. In some embodiments, characterizing the reservoir in a subsurface region of earth is based upon the probability of the property of the reservoir.

An embodiment of a method for petrophysical classification, characterization, and uncertainty estimation comprises a tangible and non-transitory machine readable medium, comprising instructions to cause a processor to receive initial well log data, generate augmented well log data comprising the initial well log data and modeled well log well log data based on the initial well log data, modify the augmented well log data to generate a training dataset, calculate a probability volume for each lithofluid class of a set of predetermined lithofluid classes utilizing the training dataset. In some embodiments, the tangible and non-transitory machine readable medium comprises instructions to cause the processor to output the probability volume for each lithofluid class of the set of predetermined lithofluid classes as a respective probability of an occurrence of a type of lithofluid class in a reservoir. In some embodiments, the tangible and non-transitory machine readable comprises instructions to cause the processor to calculate a posterior probability based on the probability volume for a first lithofluid class of the set of predetermined lithofluid classes; and output the posterior probability as a probability of a property of the reservoir. In some embodiments, the tangible and non-transitory machine readable medium comprises instructions to cause the processor to generate the augmented well log data by fitting at least one attribute of a selected rock physics model to at least a portion of the initial well log data. In other embodiments, the tangible and non-transitory machine readable medium comprises instructions to cause the processor to generate a minimum value for a model parameter of the selected rock physics model, generate a maximum value for the model parameter of the selected rock physics model, and sample across the model parameter to generate a search result. In other embodiments, the tangible and non-transitory machine readable medium comprises instructions to cause the processor to fit at least one attribute of the selected rock physics model to at least a portion of the initial well log data by comparing the search result against at least a portion of the initial well log data to generate a determination of a best fit between the search result and at least a portion of the initial well log data. In other embodiments, the tangible and non-transitory machine readable medium comprises instructions to cause the processor to apply the best fit between the search result and at least a portion of the initial well log data as the modeled well log data. In still other embodiments, the tangible and non-transitory machine readable medium comprises instructions to cause the processor to modify the augmented well log data by expanding more or more of a porosity range, saturations, fluid type, mineralogy, or volume of shale range based upon the augmented well log data to generate the training dataset.

An embodiment of a method for petrophysical classification, characterization, and uncertainty estimation comprises receiving initial well log data, utilizing the well log data to calibrate model parameters of a rock physics model to generate calibrated model parameters, and generating augmented well log data comprising the well log data and modeled well log data generated utilizing the calibrated model parameters. In some embodiments, generating the augmented well log data comprises performing a search of the calibrated model parameters with respect to the well log data. In other embodiments, generating the augmented well log data comprises performing a search of the calibrated model parameters with respect to the well log data. In other embodiments, performing the search of the calibrated model parameters comprises setting a respective minimum value and maximum value for each calibrated model parameter of the calibrated model parameters and comparing each calibrated model parameter of the calibrated model parameters with at least a portion of the well log data. In other embodiments, performing the search of the calibrated model parameters comprises generating the modeled well log data based on a comparison of each calibrated model parameter of the calibrated model parameters with at least a portion of the well log data as a best fit between each calibrated model parameter of the calibrated model parameters and at least a portion of the well log data. In still other embodiments, performing the search of the calibrated model parameters comprises modifying the augmented well log data to generate a training dataset, training a probabilistic classifier utilizing the training dataset, calculating a probability volume for each lithofluid class of a set of predetermined lithofluid classes utilizing the probabilistic classifier, and outputting the probability volume for each lithofluid class.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

Various aspects of this disclosure may be better understood upon reading the following detailed description and upon reference to the drawings in which:

FIG. 1 is an example flow chart of various processes that may be performed based on analysis of seismic data acquired via a seismic survey system;

FIG. 2 is an example of a marine survey system in a marine environment;

FIG. 3 is an example of a land survey system in a land environment;

FIG. 4 is an example of a computing system that may perform operations described herein based on data acquired via the marine survey system of FIG. 2 and/or the land survey system of FIG. 3;

FIG. 5 is an example flow diagram of a method for petrophysical classification, characterization, and uncertainty estimation as described herein;

FIG. 6 is a graphical representation of an exemplary technique utilized to calibrate a rock physics model in conjunction with step 84 of FIG. 5;

FIG. 7 is a graphical representation of another exemplary technique utilized to calibrate a rock physics model in conjunction with step 84 of FIG. 5;

FIG. 8, is a graphical representation including reservoir property predictions generated using the method illustrated with respect to FIG. 5.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Analysis of seismic data may provide valuable information, such as the location and/or change of hydrocarbon deposits within a subsurface region of the Earth. The present disclosure generally discusses techniques that may be used to improve interpretation of seismic data. More particularly, present techniques allow for improvements to a probabilistic (e.g., Bayesian) approach to classification of probabilistic elastic data volumes into lithofluid based classes, as well as calculation of the distribution of the underlying distribution of the underlying petrophysical rock properties for the purposes of reservoir characterization. Classification as used herein refers to a machine learning method where a model tries to predict the correct label or class of a given input data. This method described herein, may be utilized to estimate a subsurface rock property (e.g., lithology, porosity, fluid, rock type, etc.) from elastic properties (e.g., represented by a set of earth models, parameterized in terms of P-wave speed (Vp), S-wave speed (Vs), and density, for example, density characteristics of a rock formation or type) resulting from the inversion of processed seismic data. The generated results (e.g., 3-D probabilistic cubes) can be utilized for, for example, geological interpretation, static reservoir model building, reserves estimation, and/or 4-D studies when run on different seismic vintages.

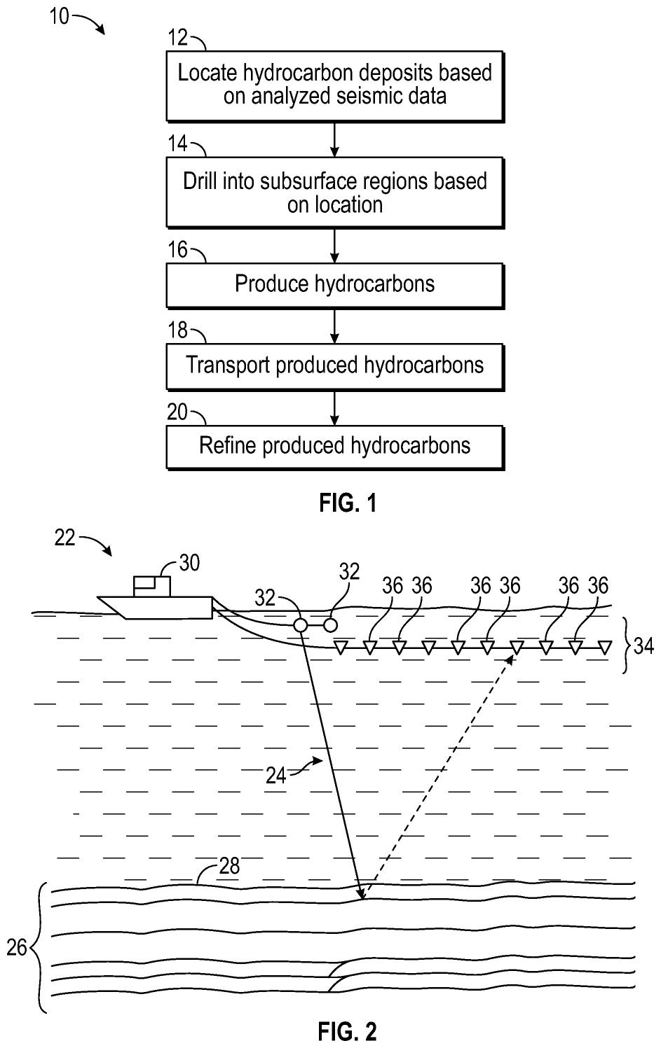

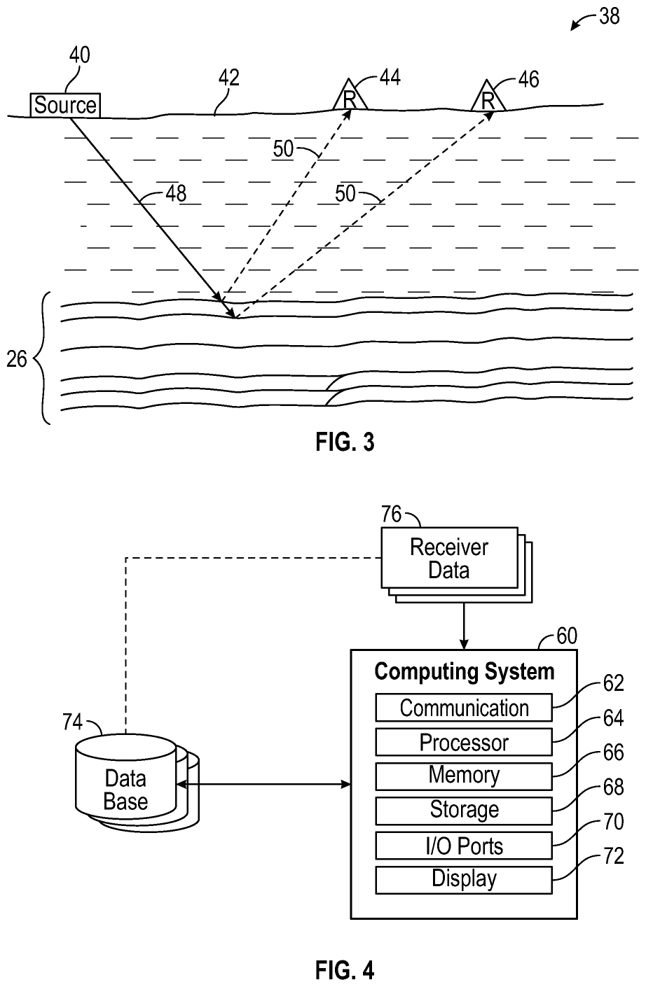

By way of introduction, seismic data may be acquired using a variety of seismic survey systems and techniques, two of which are discussed with respect to FIG. 2 and FIG. 3. Regardless of the seismic data gathering technique utilized, after the seismic data is acquired, a computing system may analyze the acquired seismic data and may use the results of the seismic data analysis (e.g., seismogram, map of geological formations, etc.) to perform various operations within the hydrocarbon exploration and production industries. For instance, FIG. 1 illustrates a flow chart of a method 10 that details various processes that may be undertaken based on the analysis of the acquired seismic data. Although the method 10 is described in a particular order, it should be noted that the method 10 may be performed in any suitable order.

Referring now to FIG. 1, at block 12, locations and properties of hydrocarbon deposits within a subsurface region of the Earth associated with the respective seismic survey may be determined based on the analyzed seismic data. In one embodiment, the seismic data acquired may be analyzed to generate a map or profile that illustrates various geological formations within the subsurface region. Based on the identified locations and properties of the hydrocarbon deposits, at block 14, certain positions or parts of the subsurface region may be explored. That is, hydrocarbon exploration organizations may use the locations of the hydrocarbon deposits to determine locations at the surface of the subsurface region to drill into the Earth. As such, the hydrocarbon exploration organizations may use the locations and properties of the hydrocarbon deposits and the associated overburdens to determine a path along which to drill into the Earth, how to drill into the Earth, and the like.

After exploration equipment has been placed within the subsurface region, at block 16, the hydrocarbons that are stored in the hydrocarbon deposits may be produced via natural flowing wells, artificial lift wells, and the like. At block 18, the produced hydrocarbons may be transported to refineries and the like via transport vehicles, pipelines, and the like. At block 20, the produced hydrocarbons may be processed according to various refining procedures to develop different products using the hydrocarbons.

It should be noted that the processes discussed with regard to the method 10 may include other suitable processes that may be based on the locations and properties of hydrocarbon deposits as indicated in the seismic data acquired via one or more seismic survey. As such, it should be understood that the processes described above are not intended to depict an exhaustive list of processes that may be performed after determining the locations and properties of hydrocarbon deposits within the subsurface region.

With the foregoing in mind, FIG. 2 is a schematic diagram of a marine survey system 22 (e.g., for use in conjunction with block 12 of FIG. 1) that may be employed to acquire seismic data (e.g., waveforms) regarding a subsurface region of the Earth in a marine environment. Generally, a marine seismic survey using the marine survey system 22 may be conducted in an ocean 24 or other body of water over a subsurface region 26 of the Earth that lies beneath a seafloor 28.

The marine survey system 22 may include a vessel 30, one or more seismic sources 32, a (seismic) streamer 34, one or more (seismic) receivers 36, and/or other equipment that may assist in acquiring seismic images representative of geological formations within a subsurface region 26 of the Earth. The vessel 30 may tow the seismic source(s) 32 (e.g., an air gun array) that may produce energy, such as sound waves (e.g., seismic waveforms), that is directed at a seafloor 28. The vessel 30 may also tow the streamer 34 having a receiver 36 (e.g., hydrophones) that may acquire seismic waveforms that represent the energy output by the seismic source(s) 32 subsequent to being reflected off of various geological formations (e.g., salt domes, faults, folds, etc.) within the subsurface region 26. Additionally, although the description of the marine survey system 22 is described with one seismic source 32 (represented in FIG. 2 as an air gun array) and one receiver 36 (represented in FIG. 2 as a set of hydrophones), it should be noted that the marine survey system 22 may include multiple seismic sources 32 and multiple receivers 36. In the same manner, although the above descriptions of the marine survey system 22 is described with one seismic streamer 34, it should be noted that the marine survey system 22 may include multiple streamers similar to streamer 34. In addition, additional vessels 30 may include additional seismic source(s) 32, streamer(s) 34, and the like to perform the operations of the marine survey system 22.

FIG. 3 is a block diagram of a land survey system 38 (e.g., for use in conjunction with block 12 of FIG. 1) that may be employed to obtain information regarding the subsurface region 26 of the Earth in a non-marine environment. The land survey system 38 may include a land-based seismic source 40 and land-based receiver 44. In some embodiments, the land survey system 38 may include multiple land-based seismic sources 40 and one or more land-based receivers 44 and 46. Indeed, for discussion purposes, the land survey system 38 includes a land-based seismic source 40 and two land-based receivers 44 and 46. The land-based seismic source 40 (e.g., seismic vibrator) that may be disposed on a surface 42 of the Earth above the subsurface region 26 of interest. The land-based seismic source 40 may produce energy (e.g., sound waves, seismic waveforms) that is directed at the subsurface region 26 of the Earth. Upon reaching various geological formations (e.g., salt domes, faults, folds) within the subsurface region 26 the energy output by the land-based seismic source 40 may be reflected off of the geological formations and acquired or recorded by one or more land-based receivers (e.g., 44 and 46).

In some embodiments, the land-based receivers 44 and 46 may be dispersed across the surface 42 of the Earth to form a grid-like pattern. As such, each land-based receiver 44 or 46 may receive a reflected seismic waveform in response to energy being directed at the subsurface region 26 via the seismic source 40. In some cases, one seismic waveform produced by the seismic source 40 may be reflected off of different geological formations and received by different receivers. For example, as shown in FIG. 3, the seismic source 40 may output energy that may be directed at the subsurface region 26 as seismic waveform 48. A first receiver 44 may receive the reflection of the seismic waveform 48 off of one geological formation and a second receiver 46 may receive the reflection of the seismic waveform 48 off of a different geological formation. As such, the first receiver 44 may receive a reflected seismic waveform 50 and the second receiver 46 may receive a reflected seismic waveform 52.

Regardless of how the seismic data is acquired, a computing system (e.g., for use in conjunction with block 12 of FIG. 1) may analyze the seismic waveforms acquired by the receivers 36, 44, 46 to determine seismic information regarding the geological structure, the location and property of hydrocarbon deposits, and the like within the subsurface region 26. FIG. 4 is a block diagram of an example of such a computing system 60 that may perform various data analysis operations to analyze the seismic data acquired by the receivers 36, 44, 46 to determine the structure and/or predict seismic properties of the geological formations within the subsurface region 26.

Referring now to FIG. 4, the computing system 60 may include a communication component 62, a processor 64, memory 66, storage 68, input/output (I/O) ports 70, and a display 72. In some embodiments, the computing system 60 may omit one or more of the display 72, the communication component 62, and/or the input/output (I/O) ports 70. The communication component 62 may be a wireless or wired communication component that may facilitate communication between the receivers 36, 44, 46, one or more databases 74, other computing devices, and/or other communication capable devices. In one embodiment, the computing system 60 may receive receiver data 76 (e.g., seismic data, seismograms, etc.) via a network component, the database 74, or the like. The processor 64 of the computing system 60 may analyze or process the receiver data 76 to ascertain various features regarding geological formations within the subsurface region 26 of the Earth.

The processor 64 may be any type of computer processor or microprocessor capable of executing computer-executable code. The processor 64 may also include multiple processors that may perform the operations described below. The memory 66 and the storage 68 may be any suitable articles of manufacture that can serve as media to store processor-executable code, data, or the like. These articles of manufacture may represent computer-readable media (e.g., any suitable form of memory or storage) that may store the processor-executable code used by the processor 64 to perform the presently disclosed techniques. Generally, the processor 64 may execute software applications that include programs that process seismic data acquired via receivers of a seismic survey according to the embodiments described herein.

With one or more embodiments, processor 64 can instantiate or operate in conjunction with one or more seismic inversion techniques. With another embodiment, the computing system 60 can be implemented by using neural networks. The one or more neural networks can be software-implemented or hardware-implemented. One or more of the neural networks can be a convolutional neural network.

The memory 66 and the storage 68 may also be used to store the data, analysis of the data, the software applications, and the like. The memory 66 and the storage 68 may represent non-transitory computer-readable media (e.g., any suitable form of memory or storage) that may store the processor-executable code used by the processor 64 to perform various techniques described herein. It should be noted that non-transitory merely indicates that the media is tangible and not a signal.

The I/O ports 70 may be interfaces that may couple to other peripheral components such as input devices (e.g., keyboard, mouse), sensors, input/output (I/O) modules, and the like. I/O ports 70 may enable the computing system 60 to communicate with the other devices in the marine survey system 22, the land survey system 38, or the like via the I/O ports 70.

The display 72 may depict visualizations associated with software or executable code being processed by the processor 64. In one embodiment, the display 72 may be a touch display capable of receiving inputs from a user of the computing system 60. The display 72 may also be used to view and analyze results of the analysis of the acquired seismic data to determine the geological formations within the subsurface region 26, the location and property of hydrocarbon deposits within the subsurface region 26, predictions of seismic properties associated with one or more wells in the subsurface region 26, and the like. The display 72 may be any suitable type of display, such as a liquid crystal display (LCD), plasma display, or an organic light emitting diode (OLED) display, for example. In addition to depicting the visualization described herein via the display 72, it should be noted that the computing system 60 may also depict the visualization via other tangible elements, such as paper (e.g., via printing) and the like.

With the foregoing in mind, the present techniques described herein may also be performed using a supercomputer that employs multiple computing systems 60, a cloud-computing system, or the like to distribute processes to be performed across multiple computing systems 60. In this case, each computing system 60 operating as part of a super computer may not include each component listed as part of the computing system 60. For example, each computing system 60 may not include the display 72 since multiple displays 72 may not be useful to for a supercomputer designed to continuously process seismic data.

After performing various types of seismic data processing, the computing system 60 may store the results of the analysis in one or more databases 74. The databases 74 may be communicatively coupled to a network that may transmit and receive data to and from the computing system 60 via the communication component 62. In addition, the databases 74 may store information regarding the subsurface region 26, such as previous seismograms, geological sample data, seismic images, and the like regarding the subsurface region 26.

Although the components described above have been discussed with regard to the computing system 60, it should be noted that similar components may make up the computing system 60. Moreover, the computing system 60 may also be part of the marine survey system 22 or the land survey system 38, and thus may monitor and control certain operations of the seismic sources 32 or 40, the receivers 36, 44, 46, and the like. Further, it should be noted that the listed components are provided as example components and the embodiments described herein are not to be limited to the components described with reference to FIG. 4.

In some embodiments, the computing system 60 may generate a two-dimensional representation or a three-dimensional representation of the subsurface region 26 based on the seismic data received via the receivers mentioned above. Additionally, seismic data associated with multiple source/receiver combinations may be combined to create a near continuous profile of the subsurface region 26 that can extend for some distance. In a two-dimensional (2-D) seismic survey, the receiver locations may be placed along a single line, whereas in a three-dimensional (3-D) survey the receiver locations may be distributed across the surface in a grid pattern. As such, a 2-D seismic survey may provide a cross sectional picture (vertical slice) of the Earth layers as they exist directly beneath the recording locations. A 3-D seismic survey, on the other hand, may create a data “cube” or volume that may correspond to a 3-D picture of the subsurface region 26.

In addition, a 4-D (or time-lapse) seismic survey may include seismic data acquired during a 3-D survey at multiple times. Using the different seismic images acquired at different times, the computing system 60 may compare the two images to identify changes in the subsurface region 26.

In any case, a seismic survey may be composed of a very large number of individual seismic recordings or traces. As such, the computing system 60 may be employed to analyze the acquired seismic data to obtain an image representative of the subsurface region 26 and to determine locations and properties of hydrocarbon deposits. To that end, a variety of seismic data processing algorithms may be used to remove noise from the acquired seismic data, migrate the pre-processed seismic data, identify shifts between multiple seismic images, align multiple seismic images, and the like.

After the computing system 60 analyzes the acquired seismic data, the results of the seismic data analysis (e.g., seismogram, seismic images, map of geological formations, etc.) may be used to perform various operations within the hydrocarbon exploration and production industries. For instance, as described above, the acquired seismic data may be used to perform the method 10 of FIG. 1 that details various processes that may be undertaken based on the analysis of the acquired seismic data.

Rock properties classification can be performed in a 2-dimensional (2-D) space that is derived from or a combination of the three properties to which seismic data respond, namely P-wave (Vp), S-wave (Vs) and Density (Rhob). Utilizing the 2-D space allows for the difficulties in accurately predicting the three independent elastic properties. However, present embodiments perform this classification in the full 3-dimensional (3-D) space (e.g., the Vp-Vs-Rhob space). This provides advantages over the traditional 2-D space, since when the classification is performed in 3-D space, it has a greater ability to separate rock and petrophysical properties. However, it should be noted that the techniques described herein can also be performed in a lower dimensional space (e.g., a 2-D space).

In one embodiment, a probabilistic prediction of the underlying elastic properties (e.g., approximately 1000 or more realizations of Vp, Vs, and Rhob) are received as input values and classification of each individual realization is performed to obtain the uncertainty due to the classification itself. Additionally, the underlying uncertainty in the estimation of the elastic parameters is incorporated in the classification. Furthermore, individual particle lithofluid classification probabilities can additionally be utilized to generate a 3-D cube of probabilistic rock properties (such as volume of shale (Vsh), saturation (Sw), total porosity (Phit), etc.) in addition to the 3-D probabilistic lithofluid classification volume in conjunction with the techniques and systems described herein.

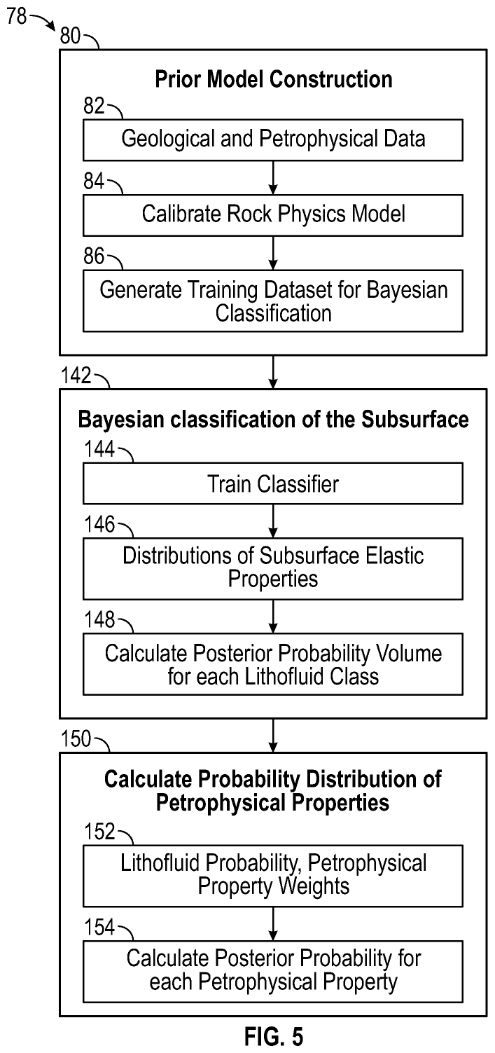

FIG. 5 illustrates one example of a technique, illustrated as a flow chart 78, to carry out classification on processed geological and petrophysical data in order to calculate a distribution of underlying petrophysical rock properties, for example, to allow for reservoir characterization. This process can be performed on the computing system 60 to analyze acquired geological and petrophysical data (e.g., performed as code stored on a tangible and non-transitory machine readable medium, such as the memory 66 and/or the storage 68, that when in operation causes the processor 64 to perform one or more of the steps of the flow chart 78 as performance of the technique).

Generally, flow chart 78 includes process 80, which represents prior model construction. Process 80, as illustrated, includes various sub-processes, which are illustrated in flow chart 78 as step 82, step 84, and step 86. In step 82 geological and petrophysical data is received by computing system 60. Examples of this data may be well logs, geological descriptions (rock types, etc.), and geophysical data. This can include, for example, measurements of reservoir properties, volume of shale, porosity, saturation, etc. However, the received geological and petrophysical data in step 82 may underrepresent variability in the subsurface region 26 (e.g., due to limited well data penetrations, especially in subsurface region 26 with relatively few wells therein). Accordingly, to construct a more robust prior model as part of process 80, rock physics modeling can be combined with the geological and petrophysical data of step 82.

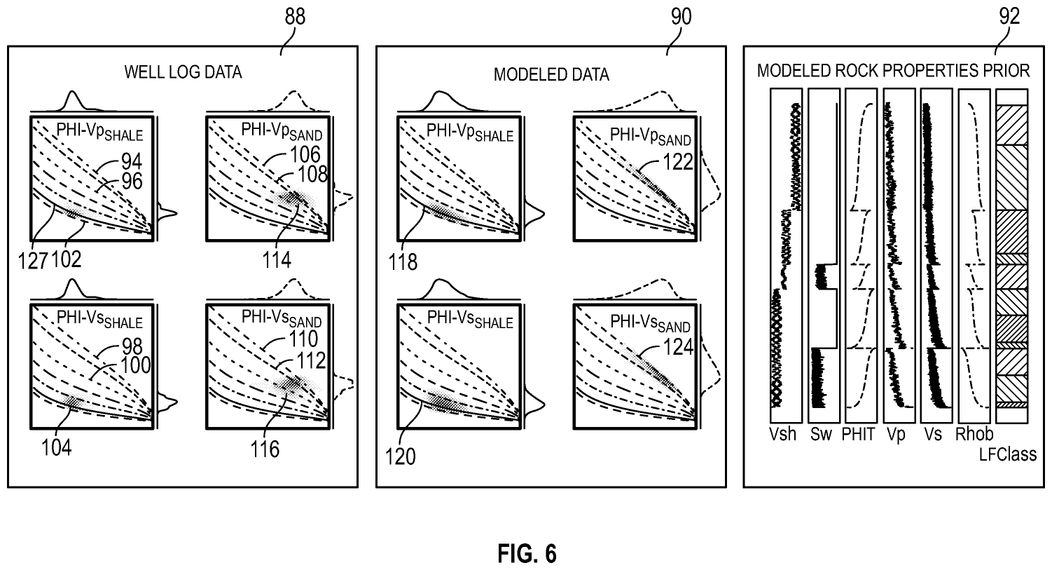

Accordingly, subsequent to the receipt in step 82 of the geological and petrophysical data, a rock physics model is calibrated in step 84 to the geological and petrophysical data of step 82. That is, in step 84, the computing system 60 operates to calibrate a rock physics model. FIG. 6 illustrates an example of a first technique utilized to calibrate a rock physics model in conjunction with step 84.

As illustrated in FIG. 6, well log data 88 (e.g., as the geological and petrophysical data of step 82 or a portion thereof) is provided to the computing system 60. As previously noted, it may be beneficial to augment this well log data, for example, with respect to a subsurface region 26 with few wells (i.e., well log data 88 that is limited). Utilization of a rock physics model allows calibration of modeled data 90 to well log data 88, after which the calibrated model can be used to generate resulting modeled rock properties prior 92. This resulting modeled rock properties prior 92 can then be utilized in additional processes, for example, to generate a training dataset that encompasses a wider range of rock properties than originally sampled in the measured data. This also operates to reduce data sparseness in Vp-Vs-Rhob space, thus diminishing the impact of the bandwidth parameter when training the classifier. Additionally, in some embodiments, data representations of unsampled geology can be generated when suitable data (e.g., well log data 88) is unavailable so that the unsampled data type can be added to the resulting modeled rock properties prior 92, thus allowing for subsequent retrieval from the resulting modeled rock properties prior 92. Thus, use of the modeled data 90 allows for inclusion of types of data (e.g., change in porosity, fluids, etc.) that is otherwise not available via the well log data 88 alone.

As illustrated in FIG. 6, the rock physics modeling can include calibrating the modeled data 90 through manual parameter fittings. Depending on the rock physics model applied, there are a number of associated parameters that can be altered (e.g., to correspond to the well log data 88). For example, in the Vp porosity domain illustrated in the well log data 88, lines 94, 96, 98, 100, 106, 108, 110, and 112 are indicative of differing sand/shale contents or ratios of the rocks (i.e., a different Vp relationship depending on the shale contents). Region 102 and region 104 represents shale data of the well log data 88. Region 114 and region 116 represent sand data of the well log data 88. FIG. 6. Successful calibration of the model results in the sand/shale ratio model lines spanning the sand and shale data points from the well logs.

The modeled data 90 can be simulated (e.g., using the associated parameters of the rock physics model applied that can be altered) and should be representative of the well log data 88 and, more particularly, regions 102, 104, 114, and 116. That is, the modeled data 90 and model lines for shale and sand contents similar to that of the well data 88 (e.g., lines 118, 120, 122, and 124) should pass through the corresponding well log data 88. This calibrated model can then be used to generate additional data that can be utilized to augment the well log data 88 when generating the modeled rock properties prior 92.

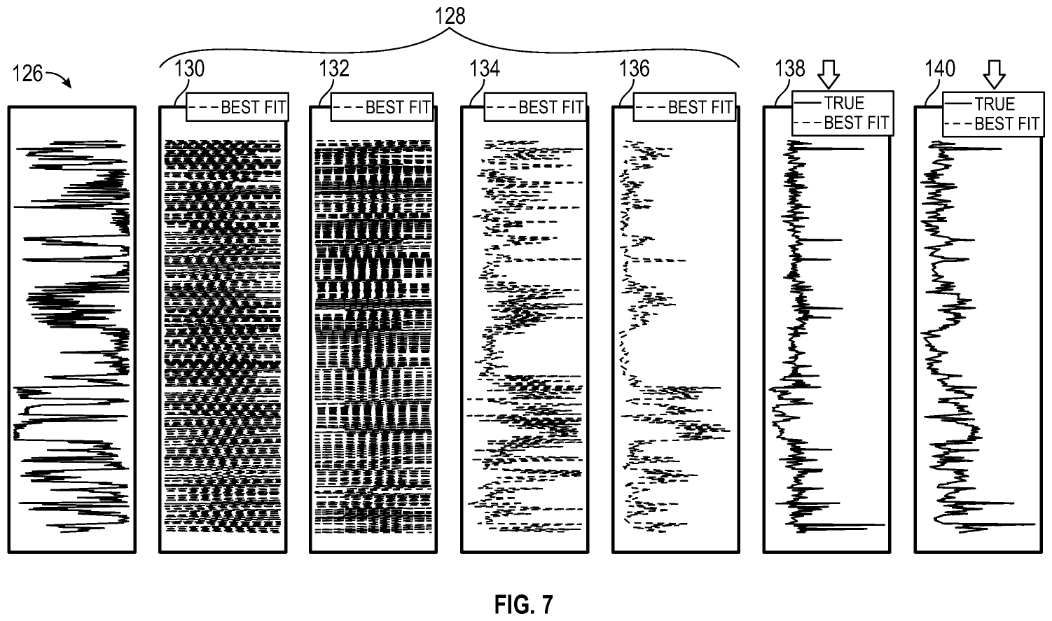

However, in some embodiments, use of the manual technique to adjust the modeled data 90 may require specialized skill to properly select the correct adjustments. Additionally, application of the manual technique described above can lead to bottlenecks in processing and/or additional costs (i.e., additional time and/or costs may result in utilizing the technique described above with respect to FIG. 6). Accordingly, in some embodiments, rock physics modeling can include an automated process, as described below in conjunction with FIG. 7.

FIG. 7 illustrates a second technique for calibrating the modeled data 90. This second technique utilizes automated parameter fittings. As illustrated, this technique includes utilizing one or more components of the geological and petrophysical data of step 82, for example, Vsh data 126. This Vsh data 126 can correspond to, for example, the region 102 and/or 114 (as illustrated in FIG. 6). This known data (i.e., the data at well control points) can be utilized to calibrate model parameters 128. As illustrated, examples of these model parameters 128 include can include a coordination factor 130, a shear stiffness variability factor 132, a mineral factor 134 (e.g., bulk modulus), and mineral factor 136 (e.g., shear modulus). Furthermore, it should be noted that these model parameters 128 are provided for reference only and fewer or greater numbers and different types of parameters can be utilized as the model parameters 128.

In conjunction with the model parameters 128 of FIG. 7, a grid search may be undertaken of the model parameters 128. That is, parameterization of the model parameters 128 may be undertaken whereby, for example, minimum and maximum values may be set for each of the model parameters 128 and sampling thereof can be undertaken across the model parameters 128 (across a set number of permutations and combinations thereof). The true data (e.g. Vsh data 126, porosity, etc.) is known during the search of each of the model parameters 128 and a best fit to the true data is determined. The best fit for each of the model parameters 128 can be selected and is represented in FIG. 7 as plotted in the bulk modulus representation 138 and the shear modulus representation 140 that includes both the true plot (based on the well log data including Vsh data 126) and the best fit data (determined via the process described above). This is in contrast to the technique described above in conjunction with FIG. 6, which would include, for example, manual selection of the coordination factor 130, the shear stiffness variability factor 132, the mineral factor 134, and the mineral factor 136. In this manner, the technique described in conjunction with FIG. 7 allows for a second technique in calibrating the rocks physics model from step 84 that overcomes at least some of the potential issues associated with the technique described above in conjunction with FIG. 6.

Thus various techniques are available to calibrate a rock physics model and, as discussed above, two of those techniques are provided herein with respect to FIG. 6 and FIG. 7. Returning to FIG. 5, the calibrated rock physics model generated in step 84 reproduce the elastic logs of available well data in the area (e.g., the subsurface region 26 of interest). Moreover, as wells typically sample only a small portion of the expected geology covered by a given seismic data cube of subsurface region 26, augmentation of that well data can be performed. By calibrating a rock physics model to the available well data, we are then able to sample rock properties from prior distributions of rock properties that are expected within the area of interest, and forward model the expected elastic response of rock properties and rock and fluid types that have not yet been directly sampled by a well. This augments the data available to train a classifier (e.g., a Bayesian classifier) in step 86 of FIG. 5.

When utilizing the technique of FIG. 7 to generate the rock physics model, for example, there may be no relation present between the coordination factor 130 and the variability factor 132 and the Vsh data 126. Accordingly, in some embodiments, the values for the coordination factor 130 and the variability factor 132 can be sampled (e.g., randomly sampled) from a uniform distribution. Similarly, with respect to the mineral factor 134 (e.g., bulk modulus) and the mineral factor 136 (e.g., shear modulus), a best fit line can be used as a mean and a selected deviation (e.g., a root mean squared deviation) can be used as a standard deviation to define a Gaussian distribution relating Vsh to mineral properties. Additionally, the mineral moduli (e.g., the mineral factor 134 and the mineral factor 136) can be sampled, for example, from a Gaussian distribution relating the Vsh to mineral properties. These samples may be utilized because, for example, the exact parameter values from the model fitting process are uncertain, as is the rock physics model itself. Because of this, it is useful to have representative statistics of them that incorporate the uncertainty and noise in the original dataset when generating the training dataset for classification in step 86. Thus, for example, given a value of Vsh data 126, a selected mineral modulus (for bulk modulus and shear modulus) can be selected from a Gaussian distribution relating the Vsh to mineral properties.

Step 86 may include, for example, expanding one or more of a porosity range, saturations, the fluid type, Vsh ranges, etc. for a dataset to be classified. This dataset that is expanded, for example, may be generated based upon the augmented data generated in step 84. Thus, because the training dataset for classification in step 86 is based upon the calibrated rock physics model of step 84, it can be altered (e.g., expanded) generated in step 86 while still providing a representation of the geological and petrophysical data of step 82 (i.e., the training dataset for classification generated in step 86 is able to reproduce the data from the geological and petrophysical data of step 82).

Flow chart 78 of FIG. 5 also includes process 142, which represents classification of the subsurface region 26 of interest. Process 142, as illustrated, includes various sub-processes, which are illustrated in flow chart 78 as step 144, step 146, and step 148. In step 144 once the available prior dataset has been constructed, the classifier is trained. Indeed, in some embodiments, the bandwidth of a kernel density estimator is optimized to obtain an optimal classifier for the training dataset from step 86, which has the available elastic logs of interest and the assigned lithofluid classes of interest available as training data. In other embodiments, additional provided algorithms and/or machine learning algorithms could also be implemented in order to determine the mapping between elastic properties and lithofluid classes.

For example, potential machine learning algorithms could be used in place of the kernel density estimator. It should be noted that the flow diagram of FIG. 5 is for illustrative purposes only. Although the example described in FIG. 5 utilizes Bayesian classification, other types of probabilistic classifiers may be utilized. A probabilistic classifier as used herein refers to a classifier that is able to predict, given an observation of an input, a probabilistic distribution across a set of classes. Bayesian classifiers comprise one type of several different probabilistic classifiers. Given the relatively low dimensionality of the Bayesian classification of the subsurface region 26 of interest (e.g., three features: Vp, Vs, Rhob), support vector machine classification could be utilized. Other options can be implemented to train the classifier, including, for example, a K nearest neighbors classifier or a support vector ensemble classification. However, it is noted that there may be an issue regarding overfitting when only a limited number of data points are available, for instance, if there was only a small amount of well data available for training. However, the rock physics modeling approach outlined above with respect to FIG. 7 has the ability to vastly expand the size of the training dataset so that machine algorithm algorithms can be applied while minimizing the risk of overfitting the data.

Once the Bayesian classifier has been trained in step 144, it is applied to samples of probability density functions that have been generated by and/or received by the computing system. These samples from the probability density functions can represent elastic volumes (i.e., distributions of subsurface elastic properties). With respect to the probability density functions, one technique for seismic analysis is amplitude variation with offset (AVO) inversion (or amplitude versus offset inversion). AVO inversion can be performed using a probabilistic approach (e.g., Bayesian approach) whereby the outcome is represented by a distribution of outcomes (e.g., a set of possible volumes) is generated and/or output. The distribution can, in some embodiments, also indicate the likelihood of each possible volume in the distribution. Thus, the probabilistic approach can generate a posterior distribution that can be utilized to access uncertainties.

Utilizing one technique, Bayesian inference is undertaken (e.g., Bayesian inference applied to the seismic data) using a probabilistic approach utilizing a sampling method, such as Markov Chain Monte Carlo (MCMC), to draw samples from the posterior distribution. Utilizing another technique, the Bayesian inference is instead performed as an optimization process to carry out Bayesian inversion on processed seismic data in order to estimate subsurface elastic parameters and their associated uncertainties. These estimates can be received in conjunction with step 146 to as an input to, for example, lithology and fluid predictions (e.g., the elastic predictions received in step 146 can be utilized in the generation of probabilities of different lithofluid classes, such as the probabilities of having different rock types, different fluids, different porosities in the rocks, etc.).

The distributions received in step 146 may be in the form of sets of particles that are separate realizations of the elastic properties. Additionally, for each set of particles (of which there may be approximately one thousand or many thousands), a probabilistic estimate of the associated lithofluid classes can be undertaken in conjunction with step 148. That is, in step 148, the received data from step 146 is passed through the classifier (as previously trained in step 144). Thus, for each particle (i.e., for each realization of Vp, Vs, Rhob), the classifier maps the respective particle into the probability for a given lithofluid class. Thus, for example, for every coordinate location in the set of data, there is a corresponding set of particles and for each realization thereof, the classifier determines a probability of it having a particular lithofluid class (e.g., a probability of being a gas sand, a brine sand, shale, etc.). Thereafter, statistics on the probability of the lithofluid classes may be calculated (e.g., in conjunction with process 150).

Process 150 of FIG. 5 include calculation of a probability density of petrophysical properties. As illustrated, process 150 includes various sub-processes, which are illustrated in flow chart 78 as step 152 and step 154. Process 150 generally operates to, for example, calculate probabilistic estimates of rock properties of interest subsequent to obtaining the probabilistic lithofluid cubes from step 148. From available training data, the weighting of rock property values associated with each lithofluid class can be calculated and, for example, by multiplying the weight by the probability of the lithofluid classes, the probabilistic estimates of petrophysical properties may be obtained. These properties could include, but are not limited to the Vsh, a net-to-gross value (e.g., a fractional volume of sand in the subsurface region 26 of interest), porosity, etc.

In step 152, the lithofluid class probabilities (generated in step 148) and petrophysical property weights can be received (e.g., from the training dataset of step 86). Thereafter, in step 154, these received values can be translated to rock property probabilities (e.g., via a mapping operation). For example, this mapping takes the lithofluid class probabilities to a Vsh probability, a porosity probability, and/or a saturation probability. In conjunction with step 154, the weighting of rock property values associated with each lithofluid class can be calculated from either the training dataset of step 86 of the well data of step 82, and multiplying the weight by the probability of the lithofluid classes so as to generate probabilistic estimates of petrophysical properties (e.g., Vsh, a net-to-gross value, porosity, etc.).

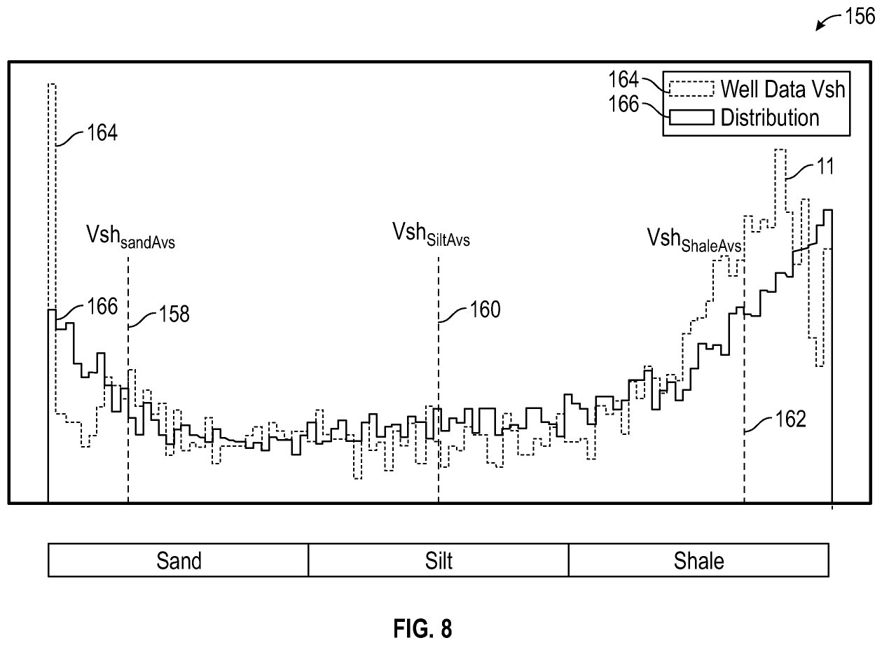

FIG. 8 illustrates an example of a result generated by process 150. More particularly, graph 156 of FIG. 8 illustrates an example when a probabilistic estimate of a petrophysical property (namely Vsh) is undertaken in conjunction with process 150. As noted above, estimates of Vsh may be generated for each of a set of lithofluid class probabilities, so these probabilities may be summed (e.g., across an oil sand case, a gas sand case, and a brine sand case) to obtain a total probability across all sands (regardless of fluid fill). Additionally, the average Vsh from the corresponding geological and petrophysical data of step 82 (or the training dataset from step 86) is generated, as illustrated, as a Vsh average for sand 158, a Vsh average for silt 160, and a Vsh average for shale 162, from the well data 164. These averages are multiplied against the aforementioned calculated respective probabilities (e.g., for each of sand, silt, and shale) and summed. This provides a Vsh estimate at a particular location in a seismic volume independent from a fluid. As further illustrated, the graph 156 also includes the generated distribution 166 of Vsh.

The aforementioned technique illustrated in conjunction with FIG. 8 can similarly be applied for other reservoir properties, for example, porosity, in a similar manner. Overall, the systems and techniques described herein operate to provide a robust sample of the posterior distribution. That is, in addition to a generated mean volume and a standard deviation volume, also, for example, bi-modal distribution, or other types of data statistics may be generated and/or represented. Moreover, the aforementioned systems and techniques allow for generation of a result from process 142 of as a probability of an occurrence of a lithofluid class (e.g., sand, gas sand, shale, etc.). Similarly, the aforementioned systems and techniques allow for generation of a result from process 150 of as a probability of a given reservoir property (e.g., probability of volume of shale, porosity, saturation, etc.). One and/or both of these results can be utilized in geological interpretation, static reservoir model building, reserves estimation, and/or 4-D studies when run on different seismic vintages.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A method, comprising:
receiving initial well log data;
generating augmented well log data comprising the initial well log data and modeled well log data based on the initial well log data;
modifying the augmented well log data to generate a training dataset;
training a probabilistic classifier utilizing the training dataset;
calculating a probability volume for each lithofluid class of a set of predetermined lithofluid classes utilizing the probabilistic classifier;
outputting the probability volume for each lithofluid class of the set of predetermined lithofluid classes as a respective probability of an occurrence of a type of lithofluid class in a reservoir;
calculating a posterior probability based on the probability volume for a first lithofluid class of the set of predetermined lithofluid classes; and
outputting the posterior probability as a probability of a property of the reservoir.

2. The method of claim 1, wherein the probabilistic classifier comprises a Bayesian classifier.

3. The method of claim 1, wherein generating the augmented well log data comprises fitting at least one attribute of a selected rock physics model to at least a portion of the initial well log data.

4. The method of claim 3, wherein fitting the at least one attribute of the selected rock physics model to the at least a portion of the initial well log data comprises:
generating a minimum value for a model parameter of the selected rock physics model;
generating a maximum value for the model parameter of the selected rock physics model; and
sampling across the model parameter to generate a search result.

5. The method of claim 4, wherein fitting the at least one attribute of the selected rock physics model to the at least a portion of the initial well log data comprises comparing the search result against the at least a portion of the initial well log data to generate a determination of a best fit between the search result and the at least a portion of the initial well log data.

6. The method of claim 5, comprising applying the best fit between the search result and the at least a portion of the initial well log data as the augmented well log data.

7. The method of claim 1, wherein modifying the augmented well log data comprises expanding one or more of a porosity range, saturations, a fluid type, mineralogy, or a volume of shale range based upon the augmented well log data to generate the training dataset.

8. The method of claim 1, comprising characterizing the reservoir in a subsurface region of Earth based upon the probability of the property of the reservoir.

9. A non-transitory machine readable medium, comprising instructions to cause a processor to:
receive initial well log data;
generate augmented well log data comprising the initial well log data and modeled well log data based on the initial well log data;
modify the augmented well log data to generate a training dataset; and
calculate a probability volume for each lithofluid class of a set of predetermined lithofluid classes utilizing the training dataset.

10. The non-transitory machine readable medium of claim 9, comprising instructions to cause the processor to output the probability volume for each lithofluid class of the set of predetermined lithofluid classes as a respective probability of an occurrence of a type of lithofluid class in a reservoir.

11. The non-transitory machine readable medium of claim 9, comprising instructions to cause the processor to:
calculate a posterior probability based on the probability volume for a first lithofluid class of the set of predetermined lithofluid classes; and
output the posterior probability as a probability of a property of a reservoir.

12. The non-transitory machine readable medium of claim 9, comprising instructions to cause the processor to generate the augmented well log data by fitting at least one attribute of a selected rock physics model to at least a portion of the initial well log data.

13. The non-transitory machine readable medium of claim 12, comprising instructions to cause the processor to:
generate a minimum value for a model parameter of the selected rock physics model;
generate a maximum value for the model parameter of the selected rock physics model; and
sample across the model parameter to generate a search result.

14. The non-transitory machine readable medium of claim 13, comprising instructions to cause the processor to fit the at least one attribute of a selected rock physics model to the at least a portion of the initial well log data by comparing the search result against the at least a portion of the initial well log data to generate a determination of a best fit between the search result and the at least a portion of the initial well log data.

15. The non-transitory machine readable medium of claim 14, comprising instructions to cause the processor to apply the best fit between the search result and the at least a portion of the initial well log data as the modeled well log data.

16. The non-transitory machine readable medium of claim 9, comprising instructions to cause the processor to modify the augmented well log data by expanding one or more of a porosity range, saturations, a fluid type, mineralogy, or a volume of shale range based upon the augmented well log data to generate the training dataset.

17. A method, comprising:
receiving well log data;
utilizing the well log data to calibrate model parameters of a rock physics model to generate calibrated model parameters; and
generating augmented well log data comprising the well log data and modeled well log data generated utilizing the calibrated model parameters.

18. The method of claim 17, wherein generating the augmented well log data comprises performing a search of the calibrated model parameters with respect to the well log data.

19. The method of claim 18, wherein performing the search of the calibrated model parameters comprises setting a respective minimum value and maximum value for each calibrated model parameter of the calibrated model parameters and comparing each calibrated model parameter of the calibrated model parameters with at least a portion of the well log data.

20. The method of claim 19, comprising generating the modeled well log data based on a comparison of each calibrated model parameter of the calibrated model parameters with the at least a portion of the well log data as a best fit between each calibrated model parameter of the calibrated model parameters and the at least a portion of the well log data.

21. The method of claim 20, comprising:
modifying the augmented well log data to generate a training dataset;
training a probabilistic classifier utilizing the training dataset;
calculating a probability volume for each lithofluid class of a set of predetermined lithofluid classes utilizing the probabilistic classifier; and
outputting the probability volume for each lithofluid class.
